(19) United States
(12) Patent Application Publication
(10) Pub. No.: US 2018/0136787 A1
(43) Pub. Date: May 17, 2018

(54) OPTICAL TOUCH PANEL DISPLAY AND METHOD OF OPERATION THEREOF

(71) Applicants: Gregory Frank Echols, Gainesville, GA (US); Kevin Leigh Walsh, Acworth, GA (US); Christopher A. Bailey, Atlanta, GA (US)

(72) Inventors: Gregory Frank Echols, Gainesville, GA (US); Kevin Leigh Walsh, Acworth, GA (US); Christopher A. Bailey, Atlanta, GA (US)

(21) Appl. No.: 15/815,278

(22) Filed: Nov. 16, 2017

Related U.S. Application Data
(60) Provisional application No. 62/422,995, filed on Nov. 16, 2016.

(51) Int. Cl. G06F 3/042; G06F 3/041

(52) U.S. Cl. CPC G06F 3/0425; G06F 3/0421; G06F 3/0414

(57) ABSTRACT

An optical touch panel includes an emitter light guide that receives and traps light from a light source. The optical touch panel also includes a collector light guide. Responsive to pressure being applied to the emitter light guide in at least one location that corresponds to at least one location on a display positioned underneath the light guides, optical coupling occurs between the emitter light guide and the collector light guide. The optical coupling causes light trapped in the emitter light guide to escape and be collected by the collector light guide. At least one optical sensor detects the collected light and determines the location at which pressure is applied to the emitter light guide that corresponds to the location on the display based on the detected collected light. The optical sensor may also determine the force of the pressure applied.

### CROSS-REFERENCE TO RELATED APPLICATION

This application claims priority to U.S. Provisional Application No. 62/422,995 filed Nov. 16, 2016, the contents of which are hereby incorporated by reference.

### TECHNICAL FIELD

The present invention relates to a touch panel. More specifically, the present invention relates to an optical touch panel display and method of operation of the same.

### BACKGROUND

Touch panels are commonly employed as user interfaces. The touch panels typically use sensors to sense the pressure of a user's finger or a stylus on a surface that at a location that corresponds to a location on a display. The sensors send signals to the display, causing a pixel at the corresponding location on the display to turn on.

Many traditional touch panels employ capacitive sensors, which create electromagnetic radiation. Such radiation is not acceptable in many environments, such as an airplane cockpit, as it may disrupt the operation of other electronic equipment.

Optical touch panels have been developed which alleviate some of the problems of traditional touch panels. However, conventional optical touch panels are ineffective under conditions with strong external light, such as sunlight. These panels may also be subject to false touch due to a foreign object landing on the surface, such as a bug or drop of moisture.

There is thus a need for a touch panel that alleviates electromagnetic interference and is effective under strong external light conditions, while also being insensitive to false touch.

### SUMMARY

The present embodiments relate to an optical touch panel and method of operating an optical touch panel. The optical touch panel includes an emitter light guide that receives and traps light from a light source. The optical touch panel also includes a collector light guide. Responsive to pressure being applied to the emitter light guide in at least one location that corresponds to at least one location on a display positioned underneath the emitter and collector light guides, optical coupling occurs between the emitter light guide and the collector light guide. The optical coupling causes light trapped in the emitter light guide to escape and be collected by the collector light guide. At least one optical sensor detects the collected light and determines the location(s) at which pressure is applied to the emitter light guide that corresponds to the location(s) on the display based on the detected collected light. The optical sensor may also determine the force of the pressure applied.

### BRIEF DESCRIPTION OF SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s) in which:

FIG. 1A illustrates an optical touch panel display system according to an illustrative embodiment.

FIG. 1B illustrates optical coupling between an emitter light guide and a collector light guide, responsive to a user's touch, according to an illustrative embodiment.

FIG. 1C illustrates an arrangement of spacer dots in an optical touch panel display system according to an illustrative embodiment.

FIG. 2 illustrates operation of the optical touch panel display system, viewed from the top, according to an illustrative embodiment.

FIG. 3A illustrates an arrangement of sensors with respect to a collector light guide according to an illustrative embodiment.

FIG. 3B illustrates details of a sensor including a linear sensor array according to illustrative embodiments.

FIG. 4A-4D illustrate results of a touch event given a pulsed light source and steady-state sunlight, according to an illustrative embodiment.

FIG. 5 illustrates an optical touch panel that includes anti-reflective coatings according to an illustrative embodiment.

FIGS. 6A and 6B illustrate an example of operation of an emitter light guide in trapping light according to an illustrative embodiment.

FIG. 6C shows a table indicating angles of incidence of a ray within an emitter light guide and corresponding angles of refraction of the ray outside the emitter light guide.

FIG. 7 illustrates an effect of anti-reflective coating on infrared light entering an emitter light guide, according to an illustrative embodiment.

FIG. 8 is a flow chart illustrating steps involved in operation of an optical touch panel display system according to an illustrative embodiment.

### DETAILED DESCRIPTION

According to illustrative embodiments, an optical touch panel is provided that alleviates electromagnetic interference and minimizes the effects of strong external light, such as sunlight, while providing multi-touch sensitive and force of pressure sensitive operation.

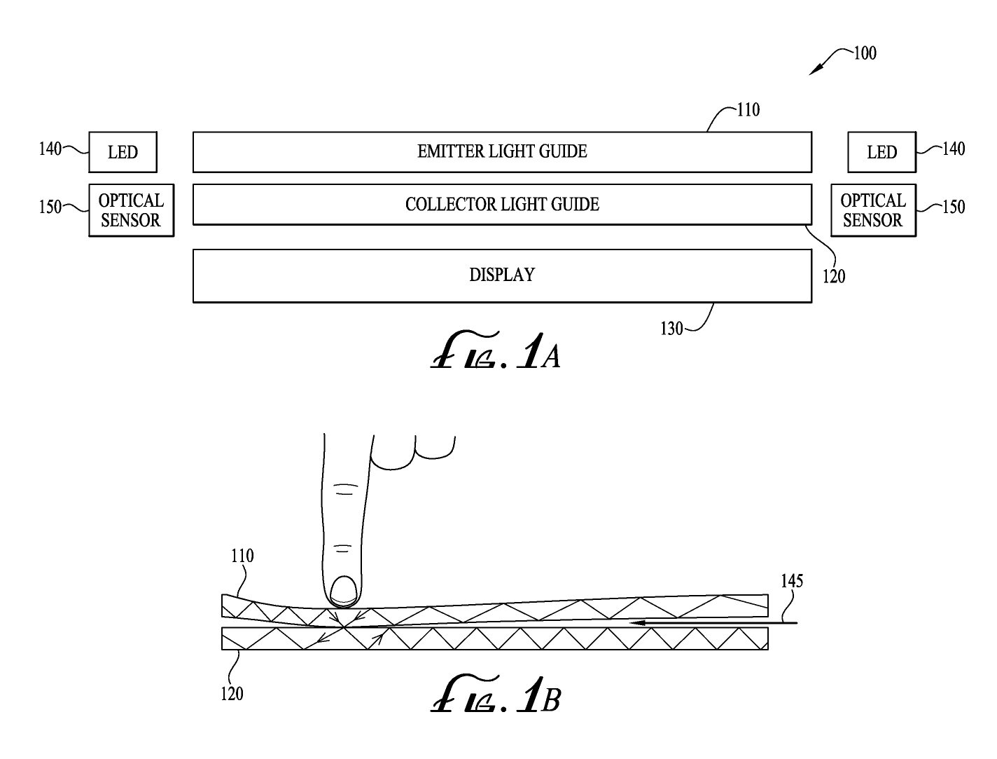

Referring to FIG. 1A, an optical touch panel display system 100 includes an emitter light guide 110, a collector light guide 120, a display 130, light sources 140 and optical sensors 150. The emitter light guide 110 and the collector light guide 120 may be made of a transparent material, such as glass, so that a user can see the display 130 through the light guides. The display 130 may be a liquid crystal display (LCD).

In the configuration shown in FIG. 1A, the emitter light guide 110 is positioned further from the display 130 than the collector light guide 120. It should be appreciated that the positions of the emitter light guide 110 and the collector light guide 120 (along with the positions of the light sources 140 and the optical sensors 150) may be reversed, such that the emitter light guide 110 is closer to the display 130. In a preferred embodiment, the emitter light guide 110 is the outermost light guide to provide additional shielding from sunlight for the collector light guide 120 that is closer to the display 130.

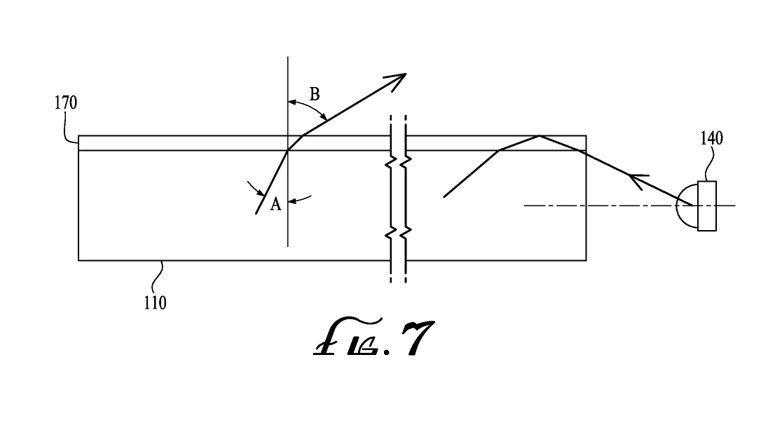

Each of the light guides 110 and 120 may include a core and a clad covering the core. In order to transfer light, the cores and the clad may be manufactured such that a refractive index of the core is greater than that of the clad. The clad also serves to act as an anti-reflective layer, to minimize reflections from the light guide when the display 130 is being viewed. This is described in more detail below with reference to FIG. 7.

The light sources 140 direct light towards the emitter light guide 110. The light sources may include light emitting diodes (LEDs) that emit monochromatic light. Infrared (IR) LEDs may be used, such that the light from the light sources 140 is not visible to the user. For example LEDs that emit infrared light at a wavelength in the range of 940 nm up to 1100 nm may be used. Such LEDs may have a correlated color appearance (CCA).

Other light sources may be used, such as an infrared laser diode or a quantum dot. In addition, different types of light sources may be used. Although two light sources 140 are shown in FIG. 1A for simplicity of illustration, it should be appreciated that any desired number of light sources may be used.

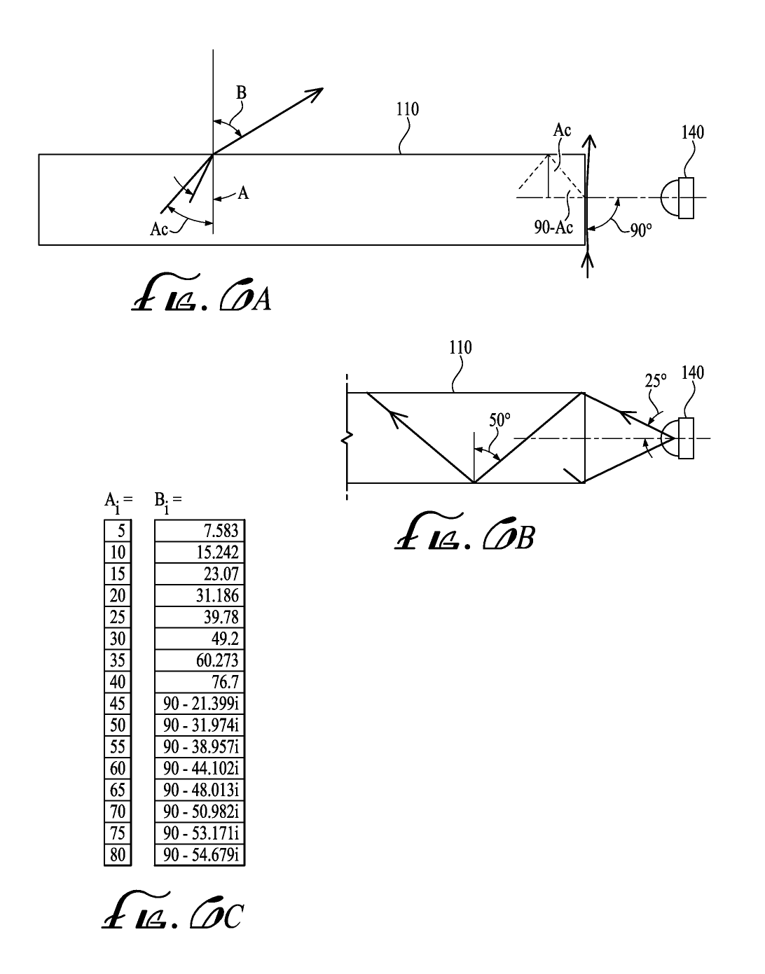

Light from the light sources 140 that strikes the emitter light guide 110 at an angle greater than the critical angle of the core of the emitter light guide 110 is reflected back into the core and is trapped there. As those skilled in the art will appreciate, the angles of incidence and reflection are equal within the core. Thus, the trapped light continues to traverse the length of the emitter light guide 110 in a zig zag pattern. This may be further understood with reference to FIGS. 6A and 6B, described below.

Although not shown in FIG. 1A, there may be a bezel around the edges of one or more components of the touch panel display system 100 that would act as a barrier or attenuator of external light, such as sunlight.

In addition, other optical techniques and mechanisms may be used for minimizing the amount of ambient light that might reach the optical sensors 150. For example, optical filters that allow the wavelengths of light emitted by the light sources 140 to pass while blocking light of other wavelengths may be used. For example, for light sources implemented with LEDs that emit light at 940 nm, with a bandwidth of 10 nm, a filter may be placed in front of each optical sensor 150, between the collector light guide 120 and each optical sensor 150. The filter may allow the collected 940 nm light to be passed to the optical sensor but block light of all other wavelengths. This filter could be plastic, and could be molded or machined to be the bezel.

Lensing systems that limit the range of angles to which the optical sensors 150 are susceptible may also be used, so that the optical sensors 150 only detect light from the collector light guide 120. As another example, fiber optic plates that have a numerical aperture that restricts the angles of light detected by the optical sensors 150 to only the angles that encompass the light from the collector light guide 120 may be used. Any of these components could be inserted, for example, between the edges of the collector light guide 120 and the optical sensors 150.

It should be appreciated that other components for enhancing the light from the light sources 140 while minimizing ambient light and other forms of optical noise may detected by the optical sensors 150 could also be used.

The emitter light guide 110 may be made of flexible material, such that when pressure is placed on the emitter light guide 110, e.g., by a user's finger(s) or a stylus, at one or more locations corresponding to one or more locations on the display 130, the emitter light guide 110 comes into contact with the collector light guide 120, causing optical coupling to occur. This optical coupling causes light to escape the emitter light guide 110 and be collected by the collector light guide 120 at the location(s) that correspond to the location(s) at which the pressure is applied.

Optical coupling between the emitter light guide 110 and the collector light guide may be further understood with reference to FIG. 1B. FIG. 1B illustrates the emitter light guide 110 receiving and trapping light 145 from a light source (not shown for simplicity of illustration). The emitter light guide 110 comes into contact with the collector light guide 120 in response to a user's touch. As noted above with regard to FIG. 1A, the positions of the light guides can be switched, with the emitter light guide 110 on top, and the collector light guide 120 on bottom.

As shown in FIG. 1B, optical coupling of the emitter light guide 110 with the collector light guide 120 allows the light in the emitter light guide 110 to enter the collector light guide 120. The collected light then travels to the edges of the collector light guide 120, where it is detected by the optical sensors 150 shown in FIG. 1A.

To avoid a “false touch”, there is a minimum amount of force required to operate the touch panel device, i.e., a minimum amount of force that will result in optical coupling between the emitter light guide 110 and the collector light guide 120. According to an illustrative embodiment, the force to operate the touch panel may be on the order of a few grams up to perhaps 80 grams (the force needed for a sturdy keyboard). Assuming a typical house fly weighs less than 1/10 of a gram, it is extremely unlikely that a flying bug (or a drop of water) would cause a false touch.

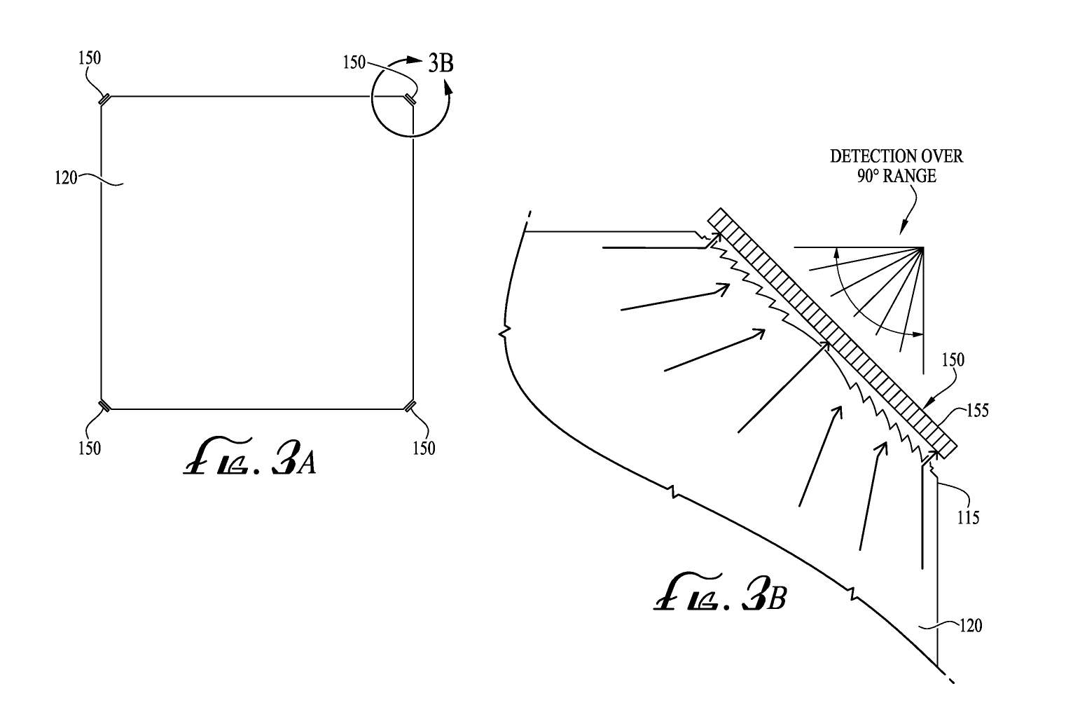

The optical sensors 150 may be placed on the edges or corners of the collector light guide 120 as shown in FIG. 3 and described in more detail below. Although two optical sensors are shown in FIG. 1A for simplicity of illustration, it should be appreciated that any number of optical sensors may be used.

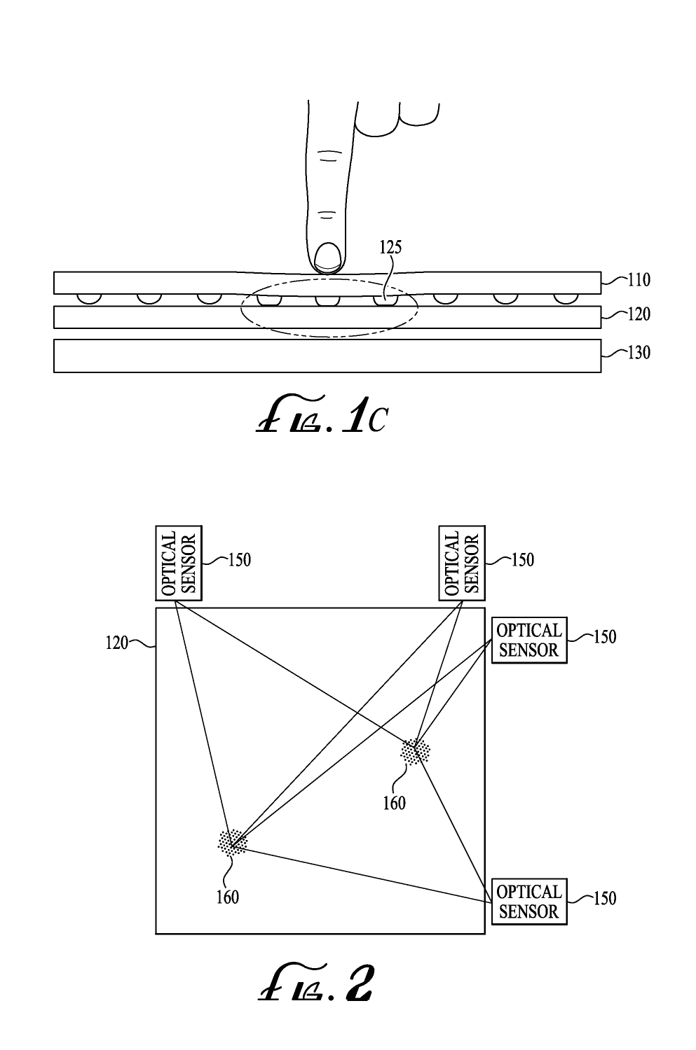

The optical sensors 150 detect the light transferred to the collector light guide 120 due to the optical coupling between the emitter light guide 110 and the collector light guide 120. Based on the detected light, the optical sensors 150 can determine the location(s) of the pressure that is applied to the emitter light guide 110, e.g., by a user's finger(s) or stylus, that corresponds to location(s) on the display 130. This may be understood with reference to FIG. 2, which shows two bright spots 160 that are visible when viewed from above the optical touch panel display system 100. These bright spots 160 appear at locations that correspond to locations on a top surface of the emitter light guide 110 to which pressure is applied. This pressure causes light trapped in the emitter light guide 110 to be transferred the collector light guide 120. This transferred light is detected by the optical sensors 150.

The optical sensors 150 determine the locations of the pressure applied on the top surface of the emitter light guide 110. The optical sensors 150, in turn, send signals to a display controller, causing the bright spots 160 to be displayed at locations on the display that correspond to the locations at which the pressure is applied to the top surface of the emitter light guide 110. That is, the optical sensors 150 detect the light collected at locations of the collector light guide corresponding to the locations of the top surface of the emitter light guide 110 to which pressure is applied. Then, the optical sensors 150 send current or voltage signals to the display controller, causing causing pixels at the locations of the display 130 that correspond to the locations of the top surface of the emitter light guide 110 to turn on and emit light that is visible as the bright spots 160. In addition to causing pixels of the display to turn on and off, it should be appreciated that the signals sent to the display controller may cause the display controller to affect any desired change to the pixels of the display 130, e.g., a “pinch”, a “zoom”, etc., at location(s) of the display corresponding to the location(s) of the touch event and other affected location(s), e.g., locations of the display corresponding to the coupling area.

Although not shown as a separate component for ease of illustration, it should be appreciated that the display controller may be integrated as part of the display 130 or may be a separate component in a manner which may be understood by one of ordinary skill in the art. The display controller may be implemented with firmware, a processor executing instructions stored in a memory as software, and/or a combination of both.

To aid in accurate determination of the location(s) of touch events on the emitter light guide 110, an arrangement of spacer dots may be included as shown in FIG. 1C. As shown in FIG. 1C, clear microscopic spacer dots 125 may be placed between the emitter light guide 110 and the collector light guide 120. The spacer dots 120 may be arranged in an array between the adjacent surfaces of the emitter light guide 110 and the collector light guide 120. The arrangement of spacer dots 125 maintains spacing between the light guides and provide specific contact points for optical contact. This makes it easier to pinpoint the location(s) of a touch event on the surface of the emitter light guide 110.

The optical sensors 150 can also determine the force of the pressure that is applied to the emitter light guide 110 based on the intensity of the light collected by the collector light guide 120. This determination may be made based on the coupling area and the intensity of the collected light. That is, the greater the force of the applied pressure to the emitter light guide 110, the greater the optical coupling, the larger the coupling area, and the greater the intensity of the light collected by the collector light guide 110. The greater the intensity of the light collected and the greater the coupling area, the greater the force of the pressure determined by the optical sensors.

The strength of the voltage or current signals sent by the optical sensors 150 to the pixels of the display may be varied to reflect the force of the pressure applied to corresponding locations on the emitter light guide. Thus, the brightness of the light emitted by the pixels at the locations of the display 130 that correspond to locations at which pressure is applied to the surface of the emitter light guide 110 may vary with the intensity of the force of the pressure.

The optical sensors 150 may be implemented with firmware, a processor executing instructions stored in a memory as software, and/or a combination of both. For example, the optical sensors may be implemented with one or more linear sensor arrays, as described below with reference to FIG. 3B. Because optical sensors are used instead of capacitive sensors, the effects of electromagnetic radiation that are problematic in conventional touch panels are alleviated.

According to one embodiment, illustrated in FIGS.3A and 3B, the optical sensors may be implemented with a linear sensor array 155 at corners of the collector light guide 120. A negative fresnel lens 115 may be used for each linear sensor array 155 to allow detection of collected light over a 90° range of angles. This configuration of sensors at each corner allows detection of collected light resulting from a touch anywhere on the surface of the emitter light guide 110.

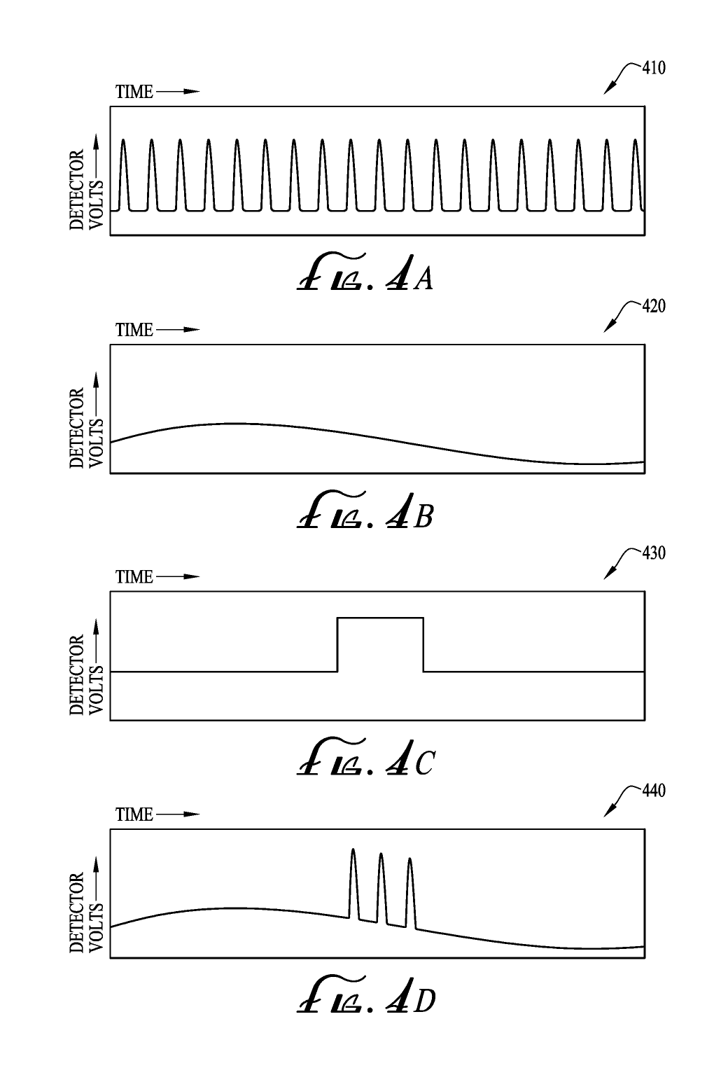

Further, the light sources 140 may be pulsed, and the optical sensors 150 may be simultaneously addressed, thereby minimizing the steady-state effect of sunlight and/or other external light. This may be understood with reference to FIGS. 4A-4D. These figures show the effect of detected collected LED signal pulses (FIG. 4A), the effect of the detected collected nominal steady-state-sunlight (FIG. 4B), and the effect of a detected touch event (FIG. 4C). The net effect of the is the detection result shown in FIG. 4D, which represents the output of an optical sensor responsive to a detected touch event with a pulsed LED light source and nominal steady-state sunlight.

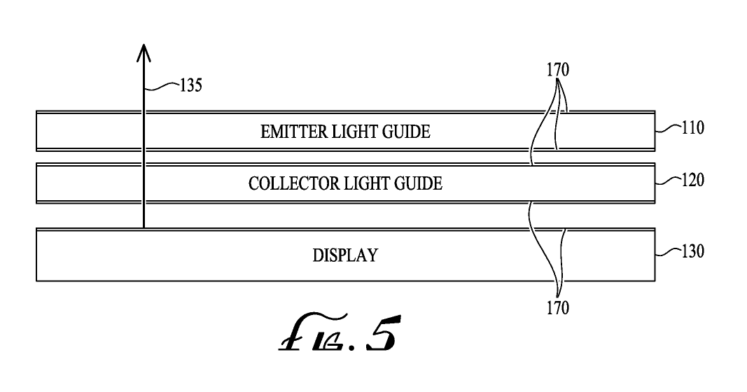

As shown in FIG. 5, anti-reflective coatings may be applied to surfaces of the emitter light guide 110, the collector light guide 120, and the display 130. According to an illustrative embodiment, the top and bottom surfaces of the emitter light guide 110 and the top and bottom surfaces of the collector light guide may each have an anti-reflective coating. In addition, the display 130 may have an anti-reflective coating on the top surface. The anti-reflective coatings are collectively referenced with reference numeral 170. Each of the anti-reflective coatings minimize reflections and glare, when viewing the light from the display (shown as the arrow 135 in FIG. 5).

These anit-reflective coatings have an added advantage in that they help serve as the ‘cladding’ for the totally-internally reflected (TIR) IR light. When the emitter and collector light guides make contact, the indices of refraction of these surface match, allowing light to pass from the emitter light guide into the collector light guide. The anti-reflective coatings have no effect on the IR light. That is, it does not reduce the internal reflectivity. In effect, for the IR rays, the anti-reflective coating is more like a cladding on a fiber optic cable.

To aid in the understanding of operation of the emitter light guide 110 described above, FIGS. 6A and 6B illustrate an example of operation of an emitter light guide which shows the basic optics of the light input into the emitter light guide for the touch panel.

With reference to FIG. 6A, as those skilled in the art will appreciate, the relationship of an angle of incidence A of light in one material, such as an emitter light guide made of glass, to the angle of refraction B in another material, such as air, is related to the indices of refraction of the materials. That is:

SIN(B)/SIN(A)=N_{glass}/Nₐᵢᵣ

SIN B=SIN(A)*N_{glass}/Nₐᵢᵣ

The index of refraction of soda-lime glass is approximately 1.514 at 1000 nm (IR) while the index of refraction of air is 1.00.

If the angle A of the an incident light ray at a critical angle Ac, the angle B of refraction B in air will be 90°, meaning that the light will not escape the emitter light guide. Thus, if the angle A of the incident light ray in the emitter light guide 110 is greater than or equal to Ac, there will be total internal reflection.

For an incident ray at the critical angle Ac, the angle of refraction B is 90, resulting in SIN (B) equals 1. The critical angle Ac may then be determined using the known indices of refraction as:

Ac=ARC SIN(N_{glass}/Nₐᵢᵣ)=ARC SIN(1.00/1.514)≈41.338

FIG. 6C depicts a table showing various angles of incidence A and angles of refraction B. As can be seen from this table and as demonstrated above, the critical angle Ac of a light beam in the soda lime glass which results in the angle of refraction B of 90° is approximately 41.338°, while an incident angle greater than 41.338° will result in an angle of refraction less than 90°.

As can be seen from FIG. 6A, a beam of light that enters the end of the emitter light guide 110 will be totally internally reflected as the index of refraction of the soda-lime glass of the emitter light guide 110 is greater than the index of refraction of air. However, as can be seen from FIG. 6A, if a beam of light strikes the end of the emitter light guide 110 at a steep angle, a lot of the beam will be reflected off the end of the light guide 110.

In contrast, as shown in FIG. 6B, a beam striking the end of the emitter light guide at a shallower angle of 25° results is les surface reflection. In general, the shallower the angle of beam entering the emitter light guide 110, the greater the amount of light that will enter into the light guide and the less will be reflected off the end. To capture any light reflected off the end, a reflector can be added from the edge of the light guide 110 to the light source 140.

It should be appreciated that the anti-reflective coating described above has no net effect on the IR rays. It causes a slight shift in the IR ray within the anti-reflective coating layer, but the input angles and final exit angles, along with the net internal reflection angles, are all the same as if the coating wasn't there. This may be understood with reference to FIG. 7 which shows the effect of an antireflective coating on an incident ray from the emitter light guide at an angle of incidence A and the resulting angle of refraction B in air.

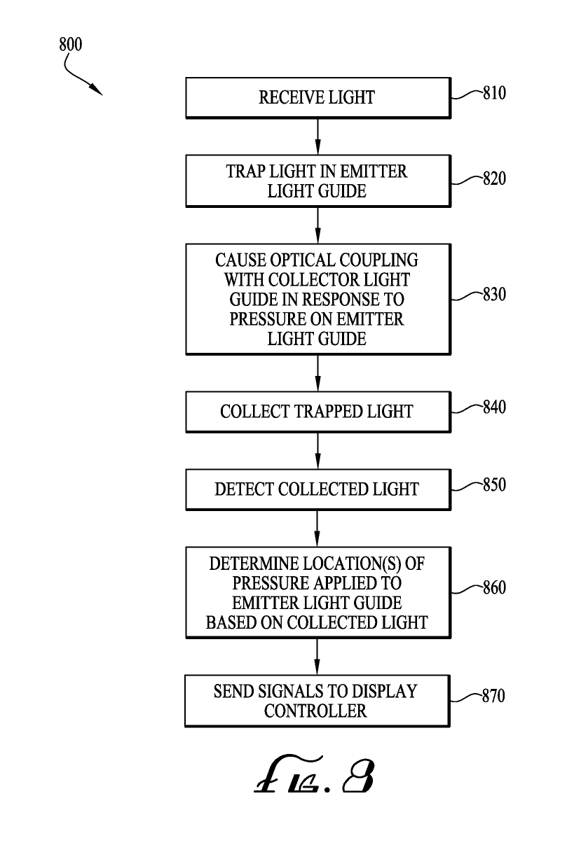

FIG. 8 is a flow chart showing steps in a process of operating an optical touch panel display according to an illustrative embodiment. The process 800 begins at step 810 at which light from a light source, such as the LED 140 shown in FIG. 1A, is received by an emitter light guide, such as the emitter light guide 110 shown in FIG. 1A. At step 820, the received light is trapped in the emitter light guide.

At step 830, optical coupling is caused between the emitter light guide and a collector light guide, such as the collector light guide 120 shown in FIG. 1A. This optical coupling is caused by pressure on a surface of the emitter light guide due to, for example, a touch event.

At step 840, the light trapped in the emitter light guide is collected by collector light guide. At step 850, optical sensors, such as the optical sensors 150 shown in FIG. 1A, detect the collected light. At step 860, the optical sensors determine the location(s) of the pressure applied to the surface of the emitter light guide based, for example, on the locations on the collector light guide at which light is detected. The optical sensors may also determine the force of the pressure based on the intensity of the detected collected light.

At step 870, the optical sensors send current or voltage signals to a display controller that controls a display, such as the display 130 shown in FIG. 1A. The signals cause the display controller to affect a change to the pixels of display 130 at location(s) corresponding to the location(s) at which pressure is applied to the emitter light guide and other affected locations, as described above.

While the various embodiments have been shown and described in example forms, it will be apparent to those skilled in the art that many modifications, additions, and deletions can be made therein without departing from the spirit and scope of the invention as defined by the following claims.

What is claimed is:

1. An optical touch panel, comprising:
an emitter light guide positioned adjacent to a light source and configured to receive and trap light emitted from the light source that is incident upon the emitter light guide at an angle that is greater than a critical angle of a core of the emitter light guide;
a collector light guide, wherein the emitter light guide and the collector light guide are configured to cause optical coupling to occur responsive to pressure on the emitter light guide in at least one location that corresponds to at least one location on a display positioned underneath the light guides, wherein the optical coupling causes light trapped in the emitter light guide to escape and be collected by the collector light guide; and
at least one optical sensor positioned adjacent to the collector light guide and configured to detect the collected light and determine the at least one location of the pressure applied to the emitter light guide that corresponds to the at least one location on the display based on the detected collected light.

2. The optical touch panel of claim 1, wherein the emitter light guide and the collector light guide are configured to cause optical coupling to occur responsive to pressure on the emitter light guide in multiple locations that correspond to multiple locations on the display, wherein the optical coupling causes light trapped in the emitter light guide to escape and be collected by the collector light guide, and wherein the optical sensor detects the collected light and determines the multiple locations of the pressure applied to the emitter light guide that correspond to the multiple locations on the display based on the detected collected light.

3. The optical touch panel of claim 1, wherein the optical sensor is further configured to sense a force of the pressure applied to the emitter light guide.

4. The optical touch panel of claim 3, wherein the greater the force of the pressure applied to the emitter light guide, the greater the optical coupling and the larger the coupling area.

5. The optical touch panel of claim 1, wherein the emitter light guide is positioned above the collector light guide, and the optical coupling occurs responsive to pressure on a top surface of the emitter light guide.

6. The optical touch panel of claim 1, further comprising a bezel around edges of the touch panel for attenuating external light.

7. The optical touch panel of claim 1, wherein the light emitted by the light source and received by the emitter light guide includes pulses of light, such that effects of external light are minimized.

8. The optical touch panel of claim 1, further comprising a plurality of optical sensors.

9. The optical touch panel of claim 1, wherein the plurality of optical sensors simultaneously sense the detected light, minimizing effects of external light.

10. The optical touch panel of claim 8, wherein the plurality of optical sensors include linear sensor arrays.

11. The optical touch panel of claim 1, wherein at least one of the emitter light guide, the collector light guide, and the display include an antireflective coating on at least one surface for minimizing reflections and glare.

12. A method of operating an optical touch panel, comprising:
receiving, by an emitter light guide, light emitted from at least one light source;
trapping, by the emitter light guide, the light that is emitted and is received at an incident angle that is greater than a critical angle of a core of the emitter light guide;
responsive to pressure on a location of the emitter light guide that corresponds to at least one location on a display, causing optical coupling to occur between the emitter light guide and a collector light guide, wherein the optical coupling causes light trapped in the emitter light guide to escape and be collected by the collector light guide; and
detecting, by at least one optical sensor, the collected light; and
determining, by the optical sensor, the at least one location of the pressure applied to the emitter light guide that corresponds to the at least one location on the display based on the detected collected light.

13. The method of claim 12, wherein optical coupling is caused to occur between the emitter light guide and the collector light guide responsive to pressure on the emitter light guide at multiple locations that correspond to multiple locations on the display, wherein the optical coupling causes light trapped in the emitter light guide to escape and be collected by the collector light guide, and wherein the optical sensor determines the multiple locations of the pressure applied to the emitter light guide that correspond to the multiple locations on the display based on the detected collected light.

14. The method of claim 12, further comprising determining a force of the pressure applied to the emitter light guide.

15. The method of claim 14, wherein the greater the pressure applied to the emitter light guide, the greater the optical coupling and the larger the coupling area.

16. The method of claim 12, wherein detecting the collected light is performed simultaneously by a plurality of optical sensors, minimizing effects of external light.

17. The method of claim 12, wherein receiving the light emitted by the light source includes receiving pulses of light, such that effects of external light are minimized

18. The method of claim 12, further comprising the optical sensor sending a signal to cause a change in a pixel of the display at a location corresponding to the location on the emitter light guide at which pressure is applied.

19. An optical touch panel display system, comprising:
a light source;
an emitter light guide positioned adjacent to the light source and configured to receive and trap light emitted from the light source that is incident upon the emitter light guide at an angle that is greater than a critical angle of a core of the emitter light guide;
a collector light guide;
a display positioned underneath the emitter light guide and the collector light guide, wherein the emitter light guide and the collector light guide are configured to cause optical coupling to occur responsive to pressure in at least one location on the emitter light guide that corresponds to at least one location on the display, wherein the optical coupling causes light trapped in the emitter light guide to escape and be collected by the collector light guide; and
at least one optical sensor positioned adjacent to the collector light guide and configured to detect the collected light and determine the at least one location of the pressure applied to the emitter light guide that corresponds to the at least one location on the display based on the detected collected light.

20. The optical touch panel display system of claim 19, wherein the emitter light guide and the collector light guide are configured to cause optical coupling to occur responsive to pressure on the emitter light guide in multiple locations that correspond to multiple locations on the display, wherein the optical coupling causes light trapped in the emitter light guide to escape and be collected by the collector light guide, and wherein the optical sensor detects the collected light and determines the multiple locations of the pressure applied to the emitter light guide that correspond to the multiple locations on the display based on the detected collected light.
